(19) United States
(12) Patent Application Publication
(10) Pub. No.: US 2011/0129659 A1
(43) Pub. Date: Jun. 2, 2011

(54) METHOD OF PRODUCING AN OPTICAL DEVICE

(75) Inventors: Koji Teranishi, Utsunomiya-shi (JP); Shinji Fukui, Utsunomiya-shi (JP); Keisui Banno, Utsunomiya-shi (JP)

(73) Assignee: CANON KABUSHIKI KAISHA, Tokyo (JP)

(21) Appl. No.: 12/953,841

(22) Filed: Nov. 24, 2010

(30) Foreign Application Priority Data
Dec. 1, 2009 (JP) 2009-273601

(51) Int. Cl. B05D 5/06; B32B 3/26

(52) U.S. Cl. 428/312.8; 427/162

(57) ABSTRACT

An optical device that includes a low refractive index film is produced at a low cost. To attain this object, in a process of producing an optical device that includes a multilayer film in which low refractive index films and high refractive index films are alternately laminated, a porous film is formed on a substrate by a sputtering deposition system which uses a target unit. The porous film is immersed in a liquid to lower the refractive index of the film. By forming in simple steps a low refractive index film that is lower in refractive index than conventionally used films, a high quality optical device can be obtained at a low cost.

### BACKGROUND OF THE INVENTION

1. Field of the Invention

The present invention relates to a method for producing a high quality optical device that includes an optical film, such as a lens and a prism that includes an anti-reflection film, or a reflecting mirror.

2. Description of the Related Art

Performance requirements of anti-reflection films in recent years include wide incident angle characteristics and wide band. A known way to satisfy these requirements is forming a multilayer optical film from multiple materials that have different refractive indices. A larger refractive index difference between the materials used means more improvement in optical performance for the multilayer optical film, and yields an optical film high in performance with respect to visible range light.

In the field of semiconductor lithography system, where integration and functional sophistication have been advanced, a projection lens high in NA is highly designed in order to minimize the critical dimension of line width. As the NA increases, lenses used in projection systems, too, are now required to have a wide band from the viewpoint of improving reflection characteristics in a high incident angle area, reducing the film phase retardation, accommodating manufacture errors, and the like. Materials having lower refractive indices are necessary to accomplish this. However, due to absorption and other matters, materials used in the vacuum ultraviolet range are limited to AlF₃, MgF₂, SiO₂, and similar substances.

Attempts have been made to lower the refractive index by forming from this type of material a film that is lower in density than conventional films. For instance, a method of producing a porous anti-reflection film by forming a mixed film of SiO₂ and NaF through vacuum evaporation and subsequently removing NaF through etching is known as a method of producing an optical film that is lower in refractive index than conventionally used magnesium fluoride films (see Japanese Patent Application Laid-Open No. H06-167601).

Japanese Patent No. 3509804 discloses a device produced by a wet process from a film having as low a refractive index as 1.25 at a wavelength of 200 nm or less. Japanese Patent No. 3509804 mentions that, in the case of a SiO₂ film produced by a wet process, the filling factor of the film can be varied between 1 and 0.5. Japanese Patent No. 3509804 also mentions that the use of a low refractive index material having an even lower refractive index is effective particularly for the improvement of reflection characteristics in a high incident angle area, the reduction of a polarization difference, and the like, and states that a low refractive index film can be produced from an organic material through a combination of a wet process such as hydrolysis and heat treatment. Japanese Patent Application Laid-Open No. 2008-76726 discloses another technology of reducing the refractive index which uses water treatment.

The method disclosed in Japanese Patent Application Laid-Open No. H06-167601 has a problem as follows. When SiO₂ and NaF are co-evaporated and the resultant film is etched with the use of water and a difference in solubility. The etching removes not only NaF but also SiO₂, thereby greatly changing the thickness of the film from the thickness prior to the removal and making it difficult to obtain desired characteristics.

The method disclosed in Japanese Patent No. 3509804 is capable of forming a low refractive index film but, because of the use of an organic material as a raw material, has a possibility that a material originated from the organic matter remains in the film and causes the absorption of a minute amount of light. Even in a minute amount, absorbed light is not negligible in projection lenses of a semiconductor lithography system which contains several tens of lenses and, through heat treatment such as organothermal treatment, leads to unignorable problems including the deformation of a quartz face of a lens.

With a technology that lowers the refractive index by water treatment as disclosed in Japanese Patent Application Laid-Open No. 2008-76726, immersing in water a MgF₂ film that is formed by conventional evaporation to a thickness of several tens nm does not dissolve the film and does not change the film's refractive index. In the case of a film that is several hundreds nm in thickness, the film is not uniform in the thickness direction (the direction in which the material of the film is deposited), and a part of the film that is close to the light incidence side is smaller in density than a part of the film that is close to the substrate side to a degree that the part of the film that is close to the light incidence side may dissolve in water.

One way to lower the density of a film that is several tens nm in thickness by water treatment is forming a film through evaporation under such conditions as no heating and high deposition pressure and thus lowering the average density of the film. With this method, a small part of the light incidence side of the film dissolves in water and is lowered in density. However, because the method lowers the density in only a part of the film that is near the surface and not in the substrate side part of the film, it is difficult to form a film that has a lower refractive index with this method.

In every one of the water immersion treatment methods described above, a film starts to dissolve from a part near the film surface and has a possibility of being reduced in thickness to the extent that desired optical characteristics are not obtained.

### SUMMARY OF THE INVENTION

The present invention has been made in view of the above, and an object of the present invention is therefore to provide an optical device producing method capable of producing a high quality optical device at a low cost by forming in simple steps a low-absorption, low-refractive index film that is applicable as, for example, an anti-reflection film for the vacuum ultraviolet range.

The method according to the present invention is a method of producing an optical device that has a thin film on its surface, including: forming a porous thin film on a substrate; and subjecting the porous thin film to liquid immersion treatment.

In the present invention, the refractive index is lowered by forming a porous film that has a specific filling factor or less at the time of film formation, and subjecting the porous film to liquid immersion treatment. A low refractive index film that absorbs little light and has a satisfactorily low refractive index is thus formed. With this low refractive index film, an optical device having wide incident angle characteristics and a wide band can be produced at a low cost.

Further features of the present invention will become apparent from the following description of exemplary embodiments with reference to the attached drawings.

### BRIEF DESCRIPTION OF THE DRAWINGS

FIGS. 1A and 1B are diagrams of Example 1, with FIG. 1A being a schematic diagram that illustrates the structure of a sputtering deposition system and FIG. 1B being an SEM image of a porous film that is formed in Example 1.

FIG. 2 is a graph showing the result of examining changes in film characteristics through N₂ purges in Example 1.

FIGS. 3A and 3B are graphs showing experiment results of Example 1, with FIG. 3A showing changes in film reflectance due to water immersion and FIG. 3B showing the relation between the water immersion time period, the refractive index (at 193 nm), and the film thickness.

FIG. 4 is a graph showing the result of examining the relation between the water immersion time period, the refractive index (at 193 nm), and the liquid temperature in Example 2.

FIGS. 5A and 5B are graphs showing experiment results of Example 3, with FIG. 5A showing changes in film reflectance due to water immersion and FIG. 5B showing the relation between the water immersion time period, the refractive index (at 193 nm), and the film thickness.

FIGS. 6A and 6B are graphs showing experiment results of Example 4, with FIG. 6A showing changes in film reflectance due to water immersion and FIG. 6B showing the relation between the water immersion time period, the refractive index (at 193 nm), and the film thickness.

FIGS. 7A and 7B are graphs of Example 4, with FIG. 7A showing the result of a laser irradiation experiment and

FIG. 7B showing the result of measuring the reflectance before and after the laser irradiation experiment.

FIG. 8 is a graph showing the result of examining the relation between the water immersion time period, the refractive index (at 193 nm), and the film thickness in Comparative Example 1.

FIGS. 9A and 9B are graphs showing experiment results of Comparative Example 2, with FIG. 9A showing the result of a water immersion experiment that is performed on an evaporation film and FIG. 9B showing the result of a water immersion experiment that is performed on a sputtering film.

### DESCRIPTION OF THE EMBODIMENTS

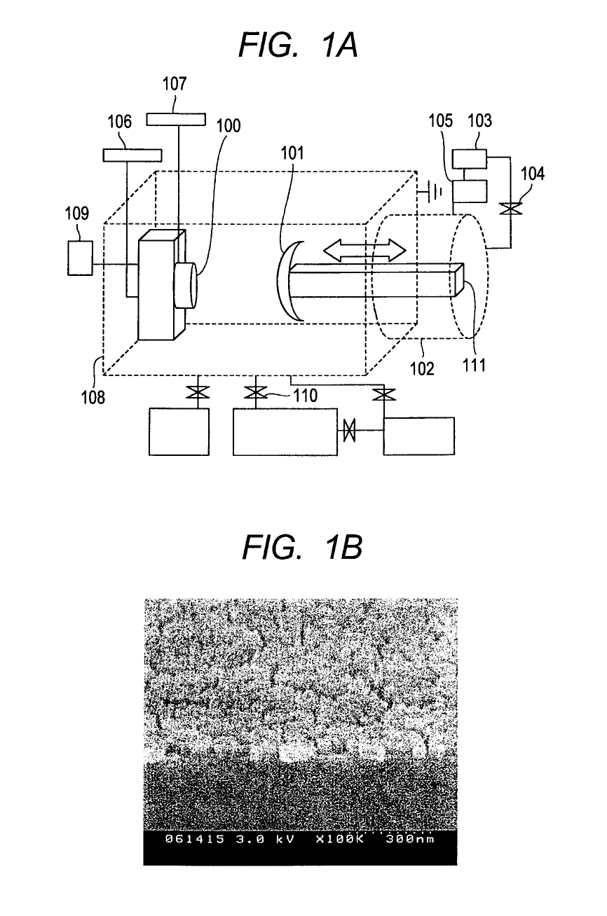

A sputtering deposition system illustrated in FIG. 1A is used to form on a substrate 101 a porous film that has a filling factor of 0.77 or less from one type of low refractive index material. The porous film is subjected to water immersion treatment (liquid immersion treatment) to reduce the refractive index of the porous film. A low refractive index film that has a predetermined refractive index is formed in this manner.

The filling factor of a film is expressed by the following expression.

(Filling factor)=(volumes of individual parts of the film)/(total volume of the film)

Generally speaking, an optical film contains multiple minute voids inside. The total volume of a thin optical film means the volume of the whole thin optical film including the film's voids. When the filling factor of an optical film is given as p, the refractive index of a substance filling the film's voids (water or air) is given as np, and the refractive index of a solid substance in the film is given as n0, a refractive index of the optical film is expressed by the following expression.

nf=n0×p+np×(1−p)

The filling factor of an optical film can thus be calculated from the refractive index of the optical film. In order to quicken water immersion treatment, it is desired to raise the temperature of a liquid used for the water immersion treatment. The water immersion treatment speed can also be enhanced with the use of an acid. Setting the liquid to a temperature of 50° C. or less produces a satisfactory effect, which means that heat damage to a lens is small and does not deform a face of the lens. The liquid used can be removed satisfactorily by nitrogen blow or a rinse with purified water or the like, and there is very little chance of contamination by impurities.

The use of a low refractive index film that has a large difference in refractive index from a high refractive index material is particularly beneficial to an anti-reflection film and gives the anti-reflection film with a high quality. An optical device produced by an optical device producing method of the present invention, where the material used exhibits low absorption characteristics in ranges including the vacuum ultraviolet range, takes favorable optical characteristics values in terms of anti-reflection performance, polarization characteristics, and incident angle dependence at an exposure wavelength. The low refractive index film lowered in refractive index through liquid immersion treatment is desired to be used as the topmost layer of an optical device, and an anti-reflection film having wider incident angle characteristics is thus obtained.

### Example 1

FIG. 1A illustrates a sputtering deposition system according to Example 1. This system forms an optical film by sputtering a metal target and letting the metal react with a reactive gas that flows into the system's chamber. Targets of various shapes can be set in a target unit 100, depending on the use. Example 1 used a ring-shaped target to form a film, but a film may be formed with the use of a target having a different shape. The sputtering deposition system is capable of forming a film while changing the position of the target unit 100 relative to the optical device substrate 101, which means that thickness unevenness throughout the plane of the substrate 101 can be adjusted as requested.

In a film forming step, a Mg metal target was set in the target unit 100, a unit having an opening was attached in front of the target unit 100 (on the substrate side), and a synthetic quartz substrate subjected to abrasive machining on the rear side and having a thickness of 30 mm was set as the substrate 101 in a vacuum antechamber 102. Next, a valve 104 of a dry pump 103 was opened for rough pumping of the vacuum antechamber 102, and then the vacuum antechamber 102 was vacuum-pumped to a high vacuum level by a turbo molecular pump 105 activated in advance. A sputtering gas supplying unit 106 and a reactive gas supplying unit 107 were then used to introduce Ar and fluorine into a deposition chamber 108 at a flow rate of 500 sccm and a flow rate of 25 sccm, respectively. A power supplying unit 109 was next used to supply the target with a DC power of 500 W via an abnormal discharge preventing system (not shown), thereby causing a discharge. After that, the degree of opening of an automatic pressure control valve 110 was adjusted and kept at approximately 2 degrees to keep the pressure within the deposition chamber 108 at approximately 5 Pa. After the discharge became steady enough, a gate valve (not shown) between the deposition chamber 108 and the vacuum antechamber 102 was opened. The substrate 101 was then transported from the vacuum antechamber 102 to the deposition chamber 108 with the use of a substrate driving shaft 111 to form, on the substrate 101, by sputtering deposition, a MgF₂ film as a porous film made from a low refractive index material.

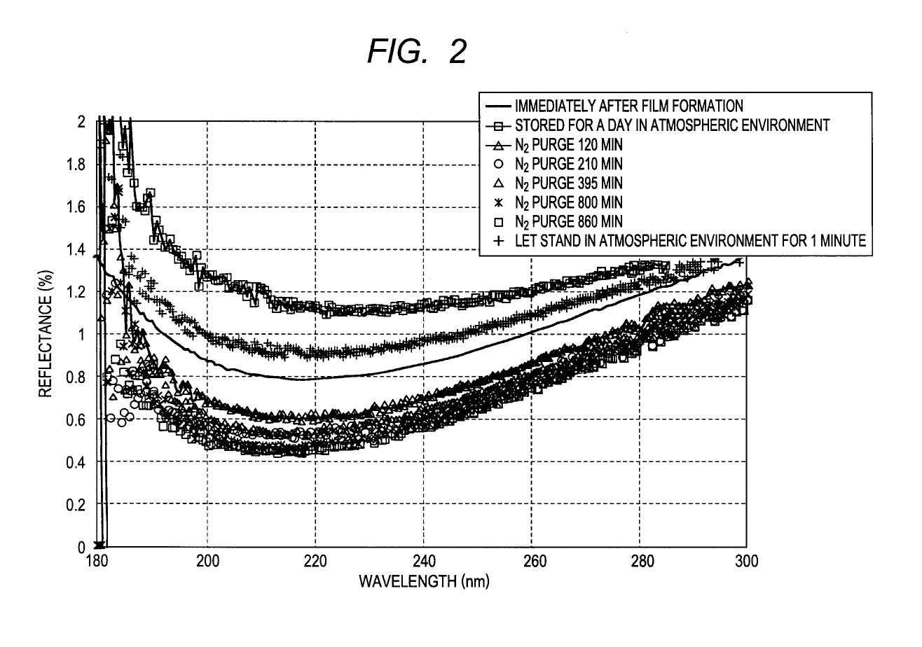

The reflectance of this film at 180 nm to 300 nm was measured by a reflectometer and, from results of the measurement, the refractive index of the film at 193 nm was calculated. The measurement was made in an N₂ purge environment and an atmospheric air environment which were dry atmosphere environments. The measurement results are shown in FIG. 2. The reflectance was measured in the ambient air immediately after the film formation and then after the film was let stand in the ambient air for a day. Subsequently, the reflectance was measured after 120-min. N₂ purge, 210-min. N₂ purge, 395-min. N₂ purge, 800-min. N₂ purge, and 860-min. N₂ purge, and then measured in the ambient air after the film was let stand in the atmospheric air for 1 minute.

It is confirmed from the graph of FIG. 2 that the reflectance rose after the just formed film was let stand in the atmospheric air for a day. The graph also confirms that the subsequent N₂ purges lowered the reflectance gradually until the reflectance steadied ultimately. Because of the porous structure of the formed MgF₂ film, moisture and other impurities are occluded into the film, absorbed to the film surface, or the like in the atmospheric air. It is therefore deduced that the refractive index of the film is raised by letting the film stand in the atmospheric air and lowered by subsequent N₂ purges in which the impurities leave the film. The reflectance of the MgF₂ film rose again when the film was taken out into the atmospheric air after enough N₂ purges were performed to remove the moisture and other impurities present in the film or on the film surface and to steady the reflection characteristics of the film. The probable cause of the rise is that the occlusion, absorption, or the like of moisture and other impurities happened for the second time by taking the film out into the atmospheric air. This means that the formed MgF₂ film is a low density film (porous film) and contains voids. The refractive index of the MgF₂ film at 193 nm after thoroughly purged with N₂ was 1.335, and the filling factor of the film calculated on the premise that the voids of the film were filled with N₂ was 0.775.

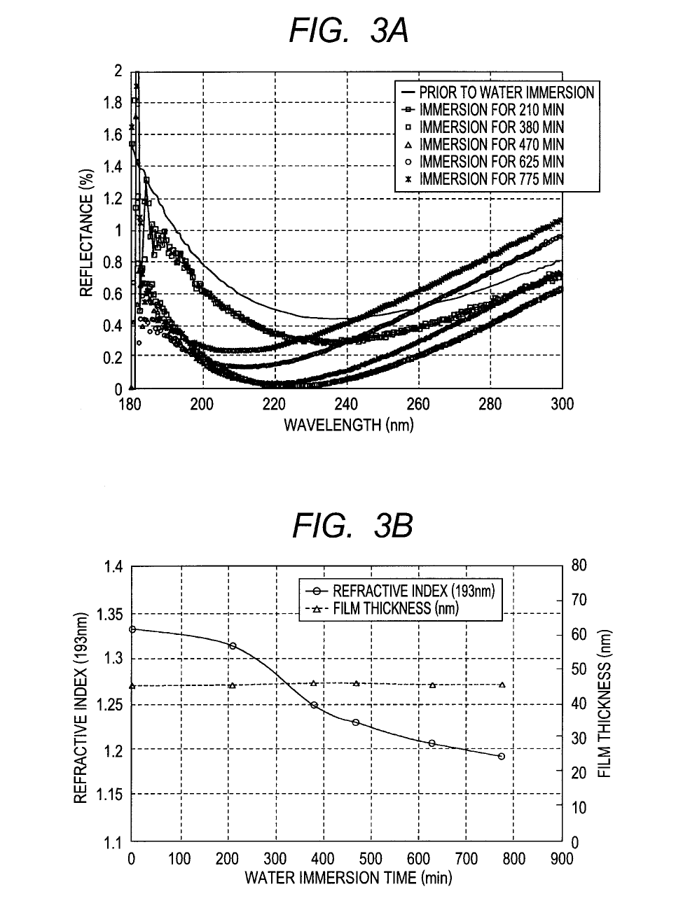

Next, the same method as the method described above was employed to form a MgF₂ film on a synthetic quartz substrate subjected to abrasive machining on the rear side and having a thickness of 30 mm. The film was immersed in purified water in a room temperature environment and the reflectance of the film was measured. FIG. 3A shows the results of measuring the reflectance in relation to the time elapsed since the start of the immersion. FIG. 3B shows, in relation to how long the film was immersed (water immersion time period or liquid immersion time period), the film's refractive index at 193 nm which is calculated from the results of measuring the reflectance. The filling factor of the film prior to the water immersion was calculated to be 0.767. The measurement was made after the immersed sample was taken out of the water, subjected to a blow of N₂ gas to remove moisture adhering to the film surface, and thoroughly dried in an N₂ purge atmosphere which was a dry atmosphere.

It is confirmed from the graph of FIG. 3B that the refractive index of the MgF₂ film decreased as the water immersion time period was prolonged, and that the refractive index at 193 nm, which was the exposure wavelength, was on the order of 1.1. FIG. 3B also confirms that the water immersion treatment changed the refractive index alone while the thickness of the film was kept intact. This is probably because a part of the MgF₂ film that had a weak grain was etched away by the purified water. It is also confirmed that the slow rate at which the refractive index dropped was advantageous to the controlled lowering of the refractive index of the MgF₂ film to a desired refractive index.

This means that, if the thickness of the film is controlled by employing dry deposition where controlling the film thickness is easy, the refractive index of the film can be controlled to a predetermined level by controlling the length of the wet treatment (liquid immersion treatment), without the fear of changing the film thickness. A MgF₂ film suitable for requested characteristics may be thus obtained. While time necessary for the liquid immersion treatment varies depending on the objective refractive index, within the range of refractive index generally required of a thin optical film, the film thickness was not largely changed during the liquid immersion treatment.

It is deduced from the above that the thin film according to the invention of this application was successfully lowered in refractive index without suffering a change in thickness because the porous thin film formed was subjected to liquid immersion treatment to fill the film's voids evenly with a liquid and, as a result, etching proceeded uniformly in the film thickness direction.

The fine structure of this film was examined with the use of a scanning electron microscope (SEM). The examination confirmed that the film had a columnar structure containing a void of 1 nm or larger in diameter between columns, and accordingly had a low density. An SEM image of the film is shown in FIG. 1B. As a result of many experiments, it was revealed that subjecting an optical film (a porous film) with a filling factor of 0.77 or less to water immersion treatment efficiently lowered the refractive index of the film.

### Example 2

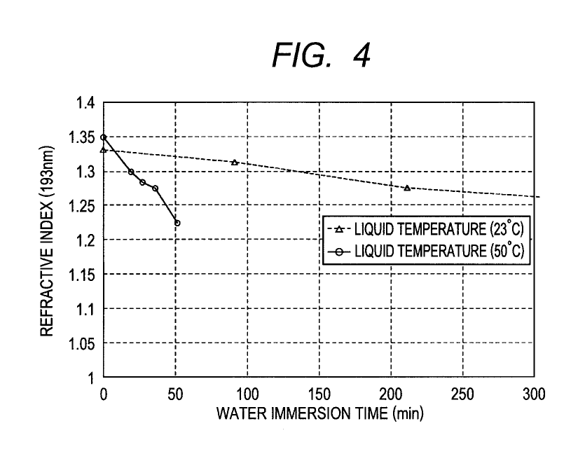

A MgF₂ film was formed by sputtering on a synthetic quartz substrate in the same way as in Example 1. A porous film formed as a result was immersed in purified water heated to 50° C. The refractive index of the MgF₂ film in relation to the water immersion time period is shown in FIG. 4. The reflectance of the film was measured in an N₂ purge atmosphere which was a dry atmosphere as in Example 1, and the refractive index was calculated from the measured reflectance.

From the graph of FIG. 4, the lowering of the refractive index as in the water immersion treatment of Example 1 is confirmed. It is also confirmed from the graph that the rate of lowering of the refractive index is improved by raising the temperature of a liquid in which the film is immersed.

### Example 3

A synthetic quarts substrate polished on each side and having a thickness of 2 mm was prepared. Sputtering was used to form on each side of the substrate a dense, six-layer film in which MgF₂ films and LaF₃ films were laminated alternately with each other. On the six-layer film on each side of the substrate, a MgF₂ film was formed as the topmost layer under a high-pressure condition as in Example 1. After that, a spectroscope was used to measure the spectral reflectance characteristics of the topmost MgF₂ film dried in an N₂ purge environment to calculate the refractive index of the MgF₂ film. At the time each six-layer film was formed, the reflectance was measured and the thickness and other attributes of the film were calculated. The refractive index was calculated through simulation by building a model in which the MgF₂ film of Example 1 was formed on the film whose attributes had been calculated. The calculated filling factor of the topmost MgF₂ film was 0.72. The absorptance of the film was also measured with the use of an absorption photometer and an ArF (193.4 nm) laser as a light source. The measured absorptance was 0.655%. Because the synthetic quartz substrate used had an absorptance of approximately 0.18% before no films were formed on the substrate, the combined optical loss of the films on the both sides of the substrate is 0.475%, which proves that the films constitute a high-quality, anti-reflection film low in absorption.

The optical loss of a film itself is expressed by the following expression.

Loss=(post-deposition absorptance)−(substrate absorptance)

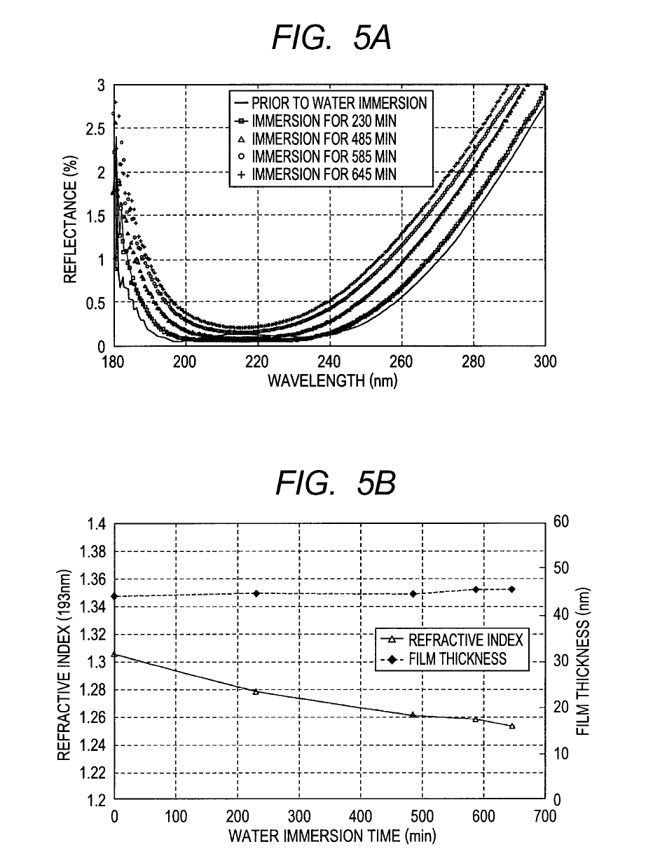

The multilayer antireflection film was subjected to water immersion treatment using purified water at room temperature in the same way as in Example 1. Results of the measurement are shown in FIG. 5A. The graph of FIG. 5A confirms that the reflectance of the multilayer anti-reflection film changed with water immersion time period. Based on the measured reflectance, a simulation in which the refractive index and thickness of the topmost MgF₂ film were varied was conducted in the manner described above, to thereby calculate changes in the refractive index and thickness of the topmost MgF₂ film. Results of the calculation are shown in FIG. 5B. The absorptance of the anti-reflection film was also measured with the use of an absorption photometer at various points in time for the duration of water immersion. Results of the measurement are shown in Table 1.

TABLE 1

Water immersion
time period (min)

| | 0 | 230 | 585 | 645 |
|---|---|---|---|---|
| Absorptance (%) | 0.655 | 0.686 | 0.6675 | 0.694 |

From the graph of FIG. 5B and Table 1, it is confirmed that, with water immersion time period, the refractive index of the topmost MgF₂ film dropped whereas the absorptance did not change significantly. It is therefore confirmed that the topmost layer alone was lowered in refractive index without affecting the underlying six-layer sputtering film.

Thus, as in the case of a single-layer MgF₂ film, a MgF₂ film formed as the topmost layer of a multilayer film, too, can be lowered in refractive index with the use of purified water, and constitutes a quality, low-refractive index film which does not change significantly in absorption value and which contains few impurities.

### Example 4

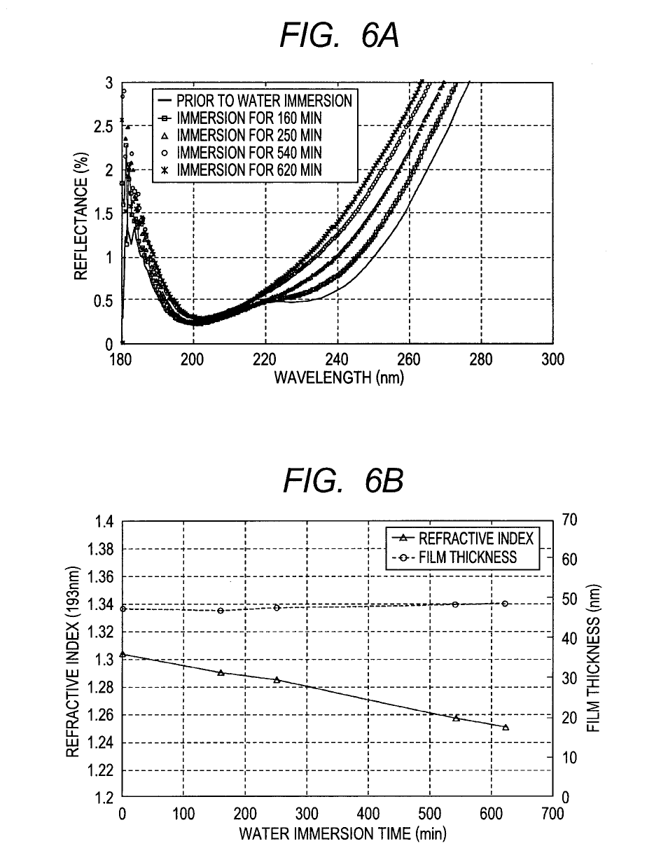

A synthetic quartz lens subjected to polishing on each side and having a thickness of 30 mm was prepared. An evaporation system was used to form, at a high vacuum level, a dense six-layer film with MgF₂ as a raw material on one side of the prepared lens. In the six-layer film, MgF₂ films and GdF₂ films were laminated alternately with each other. After that, the system of Example 1 was used to form a MgF₂ film as the topmost layer under high pressure. The filling factor of the formed topmost MgF₂ film was 0.703. Water immersion treatment using purified water at room temperature was then performed to lower the refractive index of the topmost MgF₂ film. The reflectance characteristics of the film were measured at various points in time for the duration of the water immersion. Results of the measurement are shown in FIG. 6A. Changes in refractive index at 193 nm and film thickness were calculated through simulation, and are shown in FIG. 6B in relation to the water immersion time period. It is confirmed from the graph of FIG. 6B that the refractive index was lowered by water immersion.

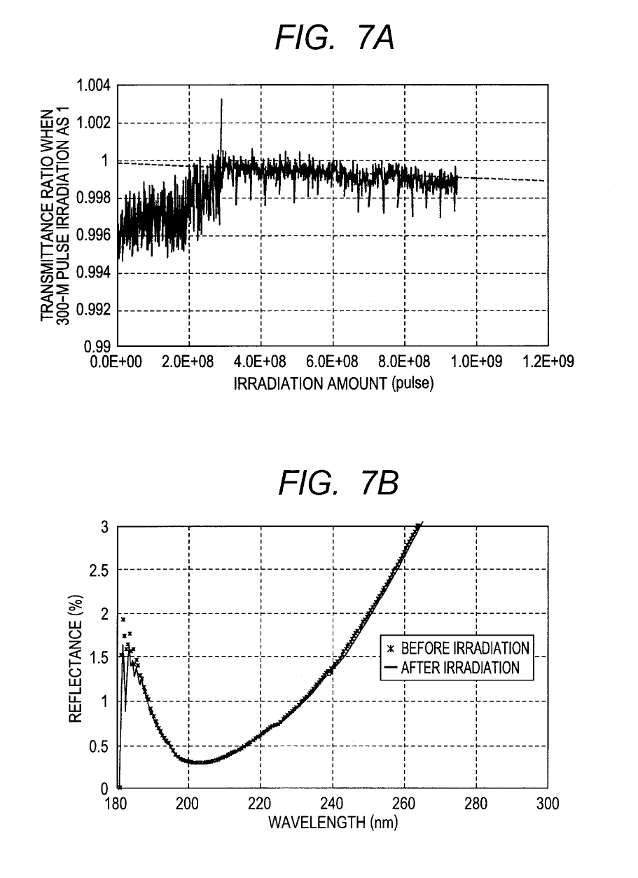

The film was next used in an ArF laser irradiation experiment. Conditions of the irradiation experiment included setting the illuminance of an ArF laser to 1.12 mJ/cm² and setting the lasing frequency of the ArF laser to 3 kHz. The laser and a power monitor for measuring the power of the laser transmitted through the lens were placed in front of and behind the film in order to calculate the transmittance of the lens from the ratio of the transmitted laser power. FIG. 7A shows relative transmittance values calculated with the transmittance to a 300-M pulse laser beam as 1. It is confirmed from the graph of FIG. 7A that the transmittance improved in an early stage of the pulse irradiation and then decreased slowly. The transmittance improved presumably because moisture and organic matter were removed from the interior of the film and from the film surface by the initial pulse laser irradiation conducted at 0×10E8 M to 3×10E8 M, and performing the irradiation in an N₂ purge removed water and other impurities from the interior of the film and from the film surface. The slope of the gradual deterioration in transmittance matches the slope of the deterioration of the quartz lens caused by laser irradiation which is indicated by the broken line in FIG. 7A. This means that the gradual deterioration is due to the deterioration in the transmittance of the quartz lens, rather than the deterioration of the film itself. It is therefore concluded that the film itself was hardly deteriorated.

The result of measuring the reflectance before and after the laser irradiation experiment is shown in FIG. 7B. It is confirmed from the graph of FIG. 7B that, because before and after the laser irradiation, the reflectance changed only by a small amount, the transmittance did not deteriorate, and the reflectance characteristics, too, did not change, the low refractive index film according to Example 4 additionally possessed light resistance with respect to the ArF laser.

### Example 5

Example 5 employs treatment with concentrated sulfuric acid instead of water immersion treatment. The first to third layers counted from the substrate side were formed by resistance heating evaporation (heating temperature: 280° C.). The surface layer (the fourth layer) was formed by dry deposition via sputtering (room temperature) or evaporation to have a film structure in which a MgF₂ film (0.59λ), a GdF₃ film (0.12λ), a MgF₂ film (0.16λ), and a MgF₂ film (0.22λ) were laminated in the order stated from the substrate (quartz) side. The thus created sample was immersed for 16 minutes in 98% concentrated sulfuric acid adjusted in temperature to 40° C. The sample was then rinsed with ultra purified water for 10 minutes and dried by blowing N₂ gas against the sample. In Example 5, a relational expression between the etching rate and the liquid temperature (Arrhenius equation) was derived through a basic experiment, to thereby determine conditions (temperature and immersion time period) under which a change in the thickness of the second layer from the surface would be ignorable. An analysis of the refractive index before and after the liquid immersion from spectral reflectance characteristics revealed that the refractive index of the topmost MgF₂ film before the immersion was 1.40 whereas its refractive index after the immersion was 1.30 (measured in an N₂ atmosphere).

### Comparative Example 1

A synthetic quartz substrate subjected to abrasive machining on one side was prepared. An evaporation system and MgF₂ as a film material were used to form a MgF₂ film on the substrate by vacuum heating. In forming the MgF₂ film, Ar was introduced into the evaporation system's chamber at a flow rate of 500 sccm and the substrate was positioned such that the incident angle of evaporated particles to the substrate was 60 degrees unheated. The objective thickness of the film being formed was 40 nm. It is known that a film formed by an evaporation method as the one described above is generally nonuniform. The reflectance of the formed film was measured with a reflectometer in an N₂ purge atmosphere and, through simulation, the refractive index at 193 nm was calculated to be approximately 1.366. The calculated filling factor of the film was 0.845. When calculated from the film's reflectance that was measured in the atmospheric air, the refractive index of the film was 1.379.

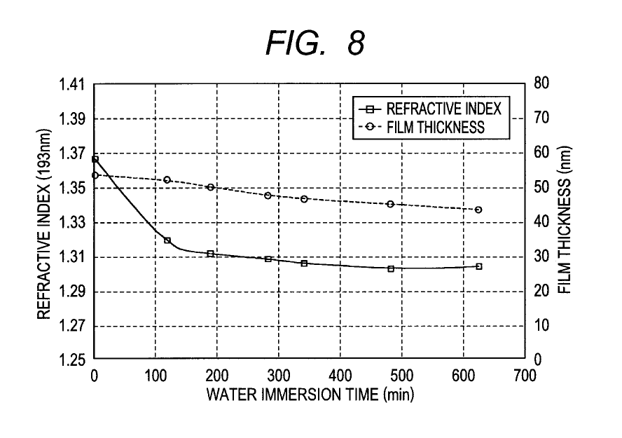

The film was immersed in purified water at room temperature and the reflectance was measured to calculate the refractive index from the measured reflectance as in Example 1. The calculated refractive index is shown in relation to the water immersion time period in FIG. 8. From the graph of FIG. 8, it is confirmed that the refractive index was lowered by water immersion, and that the refractive index at a wavelength of 193 nm was approximately 1.30.

The refractive index prior to the water immersion was not so low because the film was not uniform. Presumably, a part of the film that was near the substrate was relatively dense whereas a part of the film that was located down in the film thickness direction had a lower filling factor. Although the water immersion treatment lowered the refractive index, the lowering of the refractive index at 193 nm stopped around 1.30. It is therefore surmised that the water immersion treatment lowered the density of the low-filling factor part of the film which was close to the atmospheric air, but did not alter the high-filling density part of the film which was close to the substrate. It was also confirmed that the purified water reduced the thickness of the film in addition to lowering the density.

### Comparative Example 2

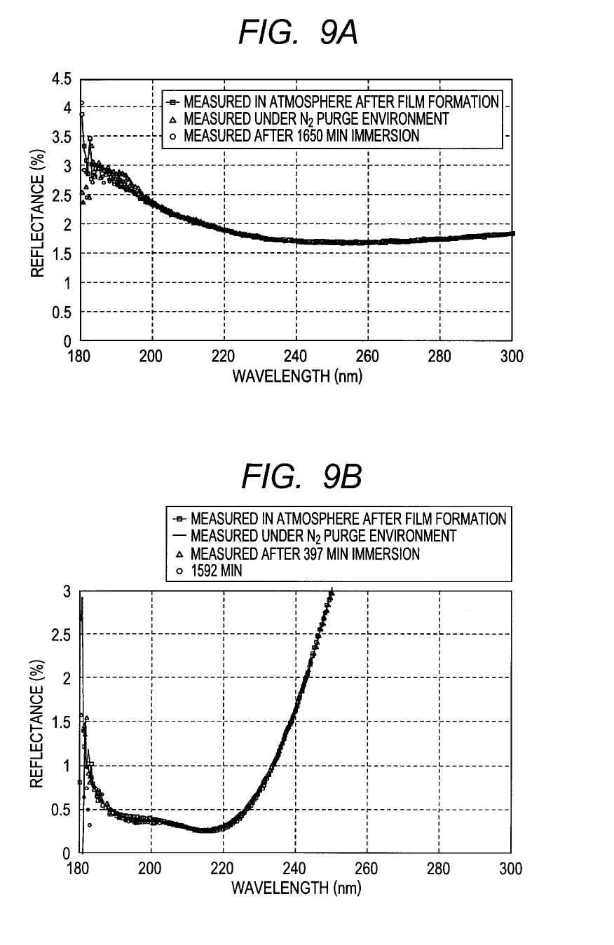

An evaporation system was used to form, by evaporation, at a high vacuum level, a MgF₂ film on a quartz substrate heated to 350° C. A sputtering system was used to form, by sputtering, a seven-layer film at a pressure of approximately 0.3 Pa by introducing Ar as a sputtering gas and F₂ gas as a reactive gas into the sputtering system's chamber. In the seven-layer film, LaF₃ films and MgF₂ films were laminated alternately with each other. The film formed by evaporation and the film formed by sputtering were each measured for reflectance by a reflectometer in the atmospheric air and in an N₂ purge. Results of the measurement are shown in FIGS. 9A and 9B. FIG. 9A shows the measurement results of the film formed by evaporation, and FIG. 9B shows the measurement results of the film formed by sputtering. From the graphs of FIGS. 9A and 9B, it is confirmed that the measured reflectance was the same irrespective of whether the measurement atmosphere was the atmospheric air or an N₂ purge atmosphere, and that the film formed by evaporation and the film formed by sputtering were both dense films. The filling factor of the film formed by evaporation and the filling factor of the film formed by sputtering were calculated to be 0.97 and 0.95, respectively.

Both films were then immersed in purified water at room temperature and measured for reflectance after the water immersion. Results of this measurement, too, are shown in FIGS. 9A and 9B. Before the reflectance measurement, moisture was removed by a blow of N₂ gas from the surfaces of both MgF₂ films taken out of an immersion bath. The MgF₂ films were then measured for reflectance in an N₂ purge environment.

It is confirmed from the graphs of FIGS. 9A and 9B that, whichever deposition method was used, the film characteristics of a film having a high filling factor were hardly changed by the subsequent water immersion treatment.

Experiment results of Example 1, Example 3, Example 4, Example 5, and both Comparative Examples are listed in Table 2.

TABLE 2

| | | Filling factor | | Change in refractive index by water | Change |
|---|---|---|---|---|---|
| | Deposition | of just | | immersion treatment/concentrated | in film |
| | method | formed film | | sulfuric acid treatment | thickness |
| Example 1 | Sputtering | 0.767 | Water 23° C. | Excellent 1.33→1.19 | Excellent |
| Example 3 | Sputtering | 0.720 | Water 23° C. | Excellent 1.31→1.25 | Excellent |
| Example 4 | Evaporation | 0.703 | Water 23° C. | Excellent 1.30→1.25 | Excellent |
| Example 5 | Evaporation | — | Concentrated | Excellent 1.40→1.30 | Excellent |
| | | | sulfuric acid 40° C. | | |
| Comparative | Evaporation | 0.845 | Water 23° C. | Good 1.37→1.30 | Bad |
| Example 1 | | | | | |
| Comparative | Evaporation | 0.97 | | Bad no change | — |
| Example 2 | Sputtering | 0.95 | | Bad no change | — |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-273601, filed Dec. 1, 2009, which is hereby incorporated by reference herein in its entirety.

What is claimed is:

1. A method of producing an optical device that has a thin film on its surface, comprising:
forming a porous thin film on a substrate; and
subjecting the porous thin film to liquid immersion treatment.

2. The method according to claim 1, wherein the thin film comprises MgF₂.

3. The method according to claim 1, wherein the liquid immersion treatment is conducted by immersing the porous thin film in a heated liquid.

4. The method according to claim 1, wherein the porous thin film has a filling factor of 0.77 or less.

5. The method according to claim 1, wherein the liquid immersion treatment uses one of water and concentrated sulfuric acid.

6. An optical device produced by the method of claim 1.
